(19) United States
(12) Patent Application Publication
(10) Pub. No.: US 2021/0323467 A1
(43) Pub. Date: Oct. 21, 2021

(54) FUNCTIONAL DOOR LINER

(71) Applicant: Honda Motor Co., Ltd., Tokyo (JP)

(72) Inventors: Kathryn A. RICHARDSON, Powell, OH (US); Nichole A. VERWYS, Marysville, OH (US); Philip Z. TEANO, Huntington Beach, CA (US)

(21) Appl. No.: 17/225,829

(22) Filed: Apr. 8, 2021

Related U.S. Application Data
(60) Provisional application No. 63/011,743, filed on Apr. 17, 2020.

(51) Int. Cl. B60Q 1/32; B60Q 3/217; B60Q 3/54; B60N 2/00

(52) U.S. Cl. CPC B60Q 1/323; B60Q 3/217; G06Q 10/02; B60N 2/002; B60Q 2400/40; B60Q 3/54

(57) ABSTRACT

A system including a light source that provides visual indications to a user of a reserved multiple-passenger vehicle. The light source operates when the user comes within a predetermined distance from the vehicle to thereby identify the vehicle as the one that was reserved by the user. The light source emits light that also specifies a predetermined seat, from among the plurality of seats, to be occupied by the user; specifies a predetermined door from among a plurality of doors by which the user should enter the vehicle to reach the predetermined seat; and specifies a predetermined path, among a plurality of paths by which the user is to travel from the exterior of the vehicle or from the predetermined door, to the predetermined seat.

### CROSS REFERENCE TO RELATED APPLICATION

This application claims priority to U.S. Provisional Patent Application Ser. No. 63/011,743 filed Apr. 17, 2020, which is expressly incorporated herein by reference.

### BACKGROUND

Vehicles includes doors for users to enter and exit the vehicle, and seats for users to occupy during travel of the vehicle. Users of vehicles select, sometimes at random, which of the doors to use for entry into the vehicle, and which of the seats to occupy during travel of the vehicles. If the vehicle is already occupied by other users, then the door selected for entry may not offer to the user the most convenient path to an unoccupied seat, and the user may then have to maneuver around the interior of the vehicle or around other users to get to an unoccupied seat, or may have to select another door for entry.

### BRIEF DESCRIPTION

According to one aspect, a light source is arranged on an associated vehicle. The light source has a sheet-like structure and is arranged on a door of the vehicle, or on a door ring of the door. The light source emits light that is visible from an exterior of the vehicle. The emitted light indicates a location of the door of the vehicle.

According to another aspect, a system for providing indications to a user of a multi-occupant vehicle includes a light source and a power source operatively connected to the light source. The light source is arranged on the vehicle and has a sheet-like structure. The light source emits light when activated by power from the power source. The emitted light indicates a location of a predetermined seat, from among a plurality of seats within the vehicle, that is assigned to the user for occupancy by the user during travel of the vehicle.

According to another aspect, a vehicle includes a plurality of seats arranged within the vehicle; and a light source arranged on the vehicle and configured to emit light when activated. The emitted light indicates to a user a predetermined path, from among a plurality of paths, between an exterior of the vehicle to a predetermined seat from among the plurality of seats. The predetermined seat is assigned to the user for occupancy by the user during travel of the vehicle.

### BRIEF DESCRIPTION OF THE DRAWINGS

FIG. 1 is a perspective exploded view of a light source according to the present subject matter.

FIG. 2 is as vehicle including a light source according to the present subject matter.

FIG. 3 is another vehicle including a light source according to the present subject matter.

FIG. 4 is a schematic side view of seat rail assemblies and a floor assembly including a light source according to the present subject matter.

FIG. 5 is a schematic side view of seat assemblies including a light source according to the present subject matter.

FIG. 6 is a schematic side view of a pillar assembly including a light source according to the present subject matter.

FIG. 7 is a top cut away view of a vehicle including a ride-share indication system according to the present subject matter.

### DETAILED DESCRIPTION

It should, of course, be understood that the description and drawings herein are merely illustrative and that various modifications and changes can be made in the structures disclosed without departing from the present disclosure.

The present subject matter provides an indication system for a multi-passenger vehicle, e.g. ride-sharing vehicle, for which a user can reserve a seat within the vehicle. When a user has reserved a seat and approaches the vehicle, a door proximate the seat (or closest to the seat from the curbside) will illuminate to indicate to the user that this vehicle is the vehicle reserved for their use, as well as an indication of what door through which the user is to enter the vehicle. For this indication, a lamp or other light source is used, and the indication may be provided to indicate to a ride-sharing user the location of their seat within a ride-sharing vehicle

After opening the vehicle door, the floor and/or seat may be illuminated with the light source to show the user where to sit within the vehicle. The light source requires no housing, and therefore may be easily applied to the floor or the seat (for example, under a fabric layer) without disturbing the outer appearance of those components.

The present subject matter provides a system delivering visual indications to a user of a multiple-passenger vehicle that includes a plurality of doors and a plurality of seats. The visual indications may specify to the user a predetermined seat, from among the plurality of seats, to be occupied by the user during travel of the vehicle; specify to the user a predetermined door from among a plurality of doors by which the user should enter the vehicle to reach the predetermined seat; specify to the user a predetermined path, among a plurality of paths by which the user is to travel from the exterior of the vehicle or from the predetermined door, to the predetermined seat; or combinations thereof.

Referring now to the drawings, wherein like numerals refer to like parts throughout the several views, the system may include a vehicle 2, and a lamp/light source 4 that emits light to provide the visual indications.

The system may be used in connection with a variety of multiple-passenger vehicles 2 including but not limited to trains, buses, boats/ships, airplanes, and automobiles including taxis, autonomous automobiles, ride-share vehicles, etc.

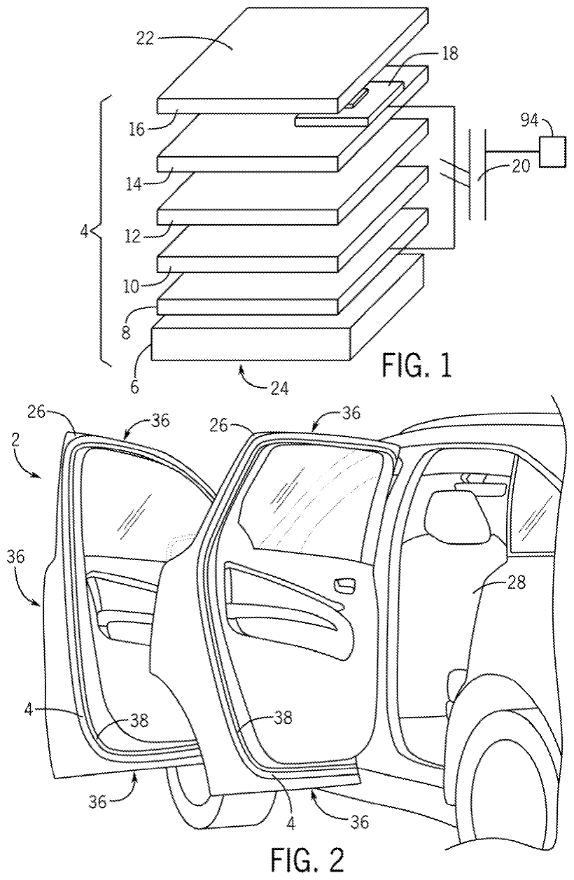

FIG. 1 depicts an exemplary schematic stacking arrangement for a light source 4. As illustrated, the light source 4 may be an electroluminescent (EL) light source including a substrate 6 (also referred to herein as “base layer”), a rear electrode 8, a dielectric layer 10, a phosphor layer 12, a front electrode 14, and a top layer 16 (also referred to herein as cover layer 16). A bus bar 18 is connected to the front electrode 14 to provide an electrical connection between the front electrode 14 and the rear electrode 8 and between the front electrode 14 and a conductive lead 20, which is connected to a power source 94 of the vehicle 2. The power source 94 may be a battery or alternator of the vehicle 2 or other power source. Other types of light sources may be used besides EL light sources.

The light source 4 emits light when activated, which is accomplished by supplying power to light source 4 through the conductive lead 20. The light source 4 may include a thin flexible sheet-like structure having two major surfaces (i.e. top surface 22 and bottom surface 24) that are oppositely directed from one another. The light source 4 may provide “two-way” illumination, wherein both of the top surface 22 and the bottom surface 24 of the light source 4 are light emitting surfaces. In other embodiments, the light source 4 provides “one-way” illumination, wherein only one of the two major surfaces (e.g. top surface 22) of the light source 4 is a light emitting surface, while the other of the two major surfaces (e.g. bottom surface 24) is not a light emitting surface.

The light source 4 may include one or more individual lamps that may operate independently from one another or collectively in order to emit light in an independent or collective manner. In a non-limiting example, the light source 4 may be in the form of electroluminescent lamps disclosed in U.S. Pat. No. 8,44,388, the contents of which is incorporated by reference herein.

As depicted, one or more top layers 16 can be provided as a transparent top coat that presents the top surface 22. The one or more top layers 16 provide protection to the light source 4, and can have a total thickness of 25 microns to 125 microns. When the light source 4 is not activated and does not emit light, the top layer(s) 16 may provide an opaque appearance. That is, when the light source 4 is not activated, the top layer 16 is not backlit by an underlying phosphor layer 12, and therefore the top layer 16 may appear to have and opaque appearance or finish.

An electrically conductive front electrode 14 is provided under the one or more top layers 16. The front electrode 14 is a film coating layer that may be both electrically conductive and generally transparent to light. The front electrode 14 may include such materials as, without limitation, conductive polymers (PEDOT), carbon nanotubes (CNT), antimony tin oxide (ATO) and indium tin oxide (ITO). An illustrative commercial product is CLEVIOS™ conductive, transparent and flexible polymers (available from Heraeus Clevios GmbH of Leverkusen, Germany) diluted in isopropyl alcohol as a thinner/drying agent. CLEVIOS™ conductive polymers exhibit relatively high efficacy. In addition, CLEVIOS™ conductive polymers are based on a styrene co-polymer and thus provides a ready mechanism for chemical crosslinking/mechanical bonding with the underlying phosphor layer 12. In a non-limiting example, the front electrode 14 has a thickness of 1 to 25 microns.

A bus bar 18 is interposed between the top layer 16 and the front electrode 14. The bus bar 18 may be provided as a relatively low-impedance strip of conductive material, usually including one or more of the materials usable to produce the bottom or rear electrode 8. In an illustrative example, the bus bar 18 includes silver. The bus bar 18 is typically applied to the peripheral edge of the lit field. Although the bus bar 18 is generally depicted as being on top of the front electrode 14, the bus bar 18 may be applied adjacent to the front electrode 14, or below the front electrode 14.

Below the front electrode 14, a phosphor layer 12 is provided. The phosphor layer 12 is a semi-conductive film coating layer including a material (such as metal-doped Zinc Sulfide (ZnS)) encapsulated within an electrostatically permeable polymer matrix. When excited by the presence of an alternating electrostatic field generated by an AC signal, the doped ZnS absorbs energy from the field, which it in turn re-emits as a visible-light photon upon returning to its ground state. In a non-limiting example, the phosphor layer 12 includes about a 2:1 solution of co-polymer and dilute ammonium hydroxide. To this solution, a quantity of metal-doped ZnS based phosphors doped with at least one of copper, manganese and silver (i.e., ZnS:Cu, Mn, Ag, etc.) pre-wetted in a dilute ammonium hydroxide is added to form a supersaturated suspension. In a non-limiting example, the phosphor layer 12 has a thickness of 30 to 100 microns.

Below the phosphor layer 12, a dielectric layer 10 is provided that electrically insulates the phosphor layer 12 from the rear electrode 8. The dielectric layer 10 may be an electrically non-conductive film coating layer including a material (typically Barium Titanate-BaTiO₃) possessing high dielectric constant properties encapsulated within an insulating polymer matrix having relatively high permittivity characteristics (i.e., an index of a given material's ability to transmit an electromagnetic field). In an illustrative example, the dielectric layer 10 includes about a 2:1 solution of co-polymer and dilute ammonium hydroxide. To this solution a quantity of BaTiO₃, which has been pre-wetted in ammonium hydroxide, may be added to form a supersaturated suspension. In embodiments providing two-way illumination, the dielectric layer 10 is transparent. In a non-limiting example, the dielectric layer 10 may include at least one of a titanate, an oxide, a niobate, an aluminate, a tantalate, and a zirconate material, among others.

Below the dielectric layer 10, a rear electrode layer 8 is provided that is electrically connected to the conductive lead 20, which is connected to the power source 94 to thereby provide power to the light source 4 for illumination thereof. The conductive lead 20 may include any of the materials that may be used for the front electrode 14 or the rear electrode 8. The rear electrode layer 8 is a film coating layer that may be a sprayable conductive material and may form the rough outline of the lit electroluminescent “field”. In a non-limiting example such as in embodiments providing one-way illumination, the rear electrode 8 may be made using a highly conductive, generally opaque material. Examples of such materials include, without limitation, an alcohol/latex-based, silver-laden solution such as SILVASPRAY™ available from Caswell, Inc. of Lyons New York, and a water-based latex, copper-laden solution such as “Caswell Copper” copper conductive paint, also available from Caswell, Inc., and mixtures thereof.

In a non-limiting example, the rear electrode 8 may be a metal plating wherein a suitable conductive metal material is applied to a non-conductive substrate 6 (which is optionally transparent) using any suitable process for the select metal plating. Example types of metal plating include, without limitation, electroless plating, vacuum metalizing, vapor deposition and sputtering. In one embodiment, the rear electrode 8 is provided on the substrate 6, with subsequent layers being formed thereon to provide an electroluminescent light source 4.

In other embodiments where two-way illumination is provided, the rear electrode 8 may include transparent materials. The rear electrode 8 may be made from an electrically conductive, generally clear transparent layer such as, without limitation, “CLEVIOS™ S V3” and or “CLEVIOS™ S V4” conductive polymers, available from Heraeus Clevios GmbH of Leverkusen, Germany. This transparent configuration for the rear electrode 8 allows for two-way illumination.

A primer layer (not shown) may be positioned between the rear electrode 8 and the substrate 6. The primer layer may be oxide-based and may serve to electrically insulate the subsequent conductive and semi-conductive layers from the substrate/transparent panel, and/or may also promote adhesion between substrate 6 and subsequently applied layers. In a non-limiting example, the primer layer may be a transparent layer, such as a transparent polymeric material. Illustrative examples include polyurethane coatings such as single or two-component polyurethane systems.

The conductive lead 20 can be electrically connected to power source 94 to thereby electrically connect the light source 4 to the power source 94. During operation, a voltage supply through the conductive lead 20 can be varied to change a brightness of the light source 4. Also, a frequency of the power supplied to the conductive lead 20 can be varied to change a color of the light source 4.

The light source 4 can be included in a variety of shapes, sizes, configurations, and locations within or on the vehicle 2, and may include a one or more individual lamps, or may include a single lamp that has more than one dielectric layer 10, more than one front electrode 14, more than one rear electrode 8, a common phosphor layer 12, and a common top layer 22. The multiple dielectric layers 10 may be electrically isolated from one another by gaps filled with a non-conductive material, such as a non-conductive polymer, as can the multiple electrode layers 8, 14. In this configuration, various regions of the lit field of electroluminescent lamp can be separately activated to thereby emit light from different portions (e.g. right side or left side) of the electroluminescent lamp. In accordance with the present disclosure, the vehicle 2 can include additional electroluminescent lamps as desired other than those specifically described herein.

Because the light source 4 is flexible, it can be conformed to the contours and shape of the base layer 6, which may include complex curves. The base layer 6 may include a surface of the vehicle 2 with the other layers being built up upon the surface, or the base layer 6 may include a flexible film used to prepare a stand-alone light source 4, which may then be applied to a surface of the vehicle 2. The substrate 6 may be a film layer (e.g. plastic film) or other layer that gives structure to the light source 4, which thereby may allow the light source 4 to be assembled first, and thereafter be mounted on an underlying component of the vehicle, such as the door 26 or door ring 34. Alternatively, the substrate 6 may itself be the door 26, door ring 34, or other components, where the other layers of the light source 4 are formed directly on the door 26, door ring 34, or other component acting as the substrate 6.

Although the present subject matter is described primarily in terms of an electroluminescent light source emitting light, it will be understood that the illumination mechanism is not limited in any way. Illustrative examples include a light emitting diode and an organic light-emitting diode configured in a film or sheet that is positionable on the base layer 6.

The system may operate to provide visual indications to an intended user of the vehicle 2, which indications communicate to the user that the vehicle 2 is intended to be used by the user, e.g. to transport the user from one location to another. The user may be predetermined (i.e. identified) as an intended user of the vehicle 2, for example, by communication via a network 100 between a computing device 96 associated with the vehicle 2 and a computing device 98 associated with the user, such as a mobile phone. The user may reserve the use of the vehicle 2 and the occupancy of the predetermined seat, via this or other communication.

The system may provide these indication by activating the light source 4 to emit light that is visible to the user. The activation of the light source 4 may be based a proximity of the user to the vehicle. This may include activating the light source 4 when the user comes within a predetermined distance from the vehicle 2, e.g. as the vehicle 2 is approaching the user or as the user is approaching the vehicle 2. The determination of whether the user comes within the predetermined distance may be based on, for example, communication via the network 100 between the computing device 96 associated with the vehicle 2 and the computing device 98 associated with the user, such as a mobile phone. The activation of the light source 4 is not limited to being based on a proximity of the user to the vehicle 2, and may activated to emit light based on other criteria such as, but not limited to, various functions or a status of the vehicle 2.

With reference to FIGS. 2, 3, and 7, the vehicle 2 may include a plurality of doors 26 and a plurality of seats 28. The light source 4 may be activated to provide a visual indication of i) a location of a predetermined door from among the plurality of doors 26, ii) a location of a predetermined seat from among the plurality of seats 28, iii) a predetermined path, from among a plurality of paths 30, from an exterior 32 of the vehicle 2 of from the predetermined door, to the predetermined seat, or iv) a combination thereof. The light source 4 may be arranged on each door 26 of the vehicle 2, on each door ring 34 of the plurality of doors 26, or on a combination thereof.

The predetermined seat may be established from among the plurality of seats 28 based on a random selection by a user or by the computing device associated with the vehicle 2, or based on a deliberate selection by the user or by the computing device associated with the vehicle 2. The predetermined door may be established from among the plurality of doors 26 based on the predetermined door being closest among the plurality of doors 26 to the predetermined seat, based on the predetermined door being closest being closest to the user when the user is at the exterior 32 of the vehicle 2, or based on other users in the vehicle 2 blocking other doors 26. The predetermined path may be established from among the plurality of paths 30 based on the predetermined path being the most-direct route among the plurality of paths 30 between the exterior 32 or the predetermined door, and the predetermined seat, based on the predetermined path being the easiest for the user to take to get to the predetermined seat, or based on the other paths 30 being blocked by other users of the vehicle 2. The predetermined seat, the predetermined door, and the predetermined path may be established based on other considerations.

1. Predetermined Door

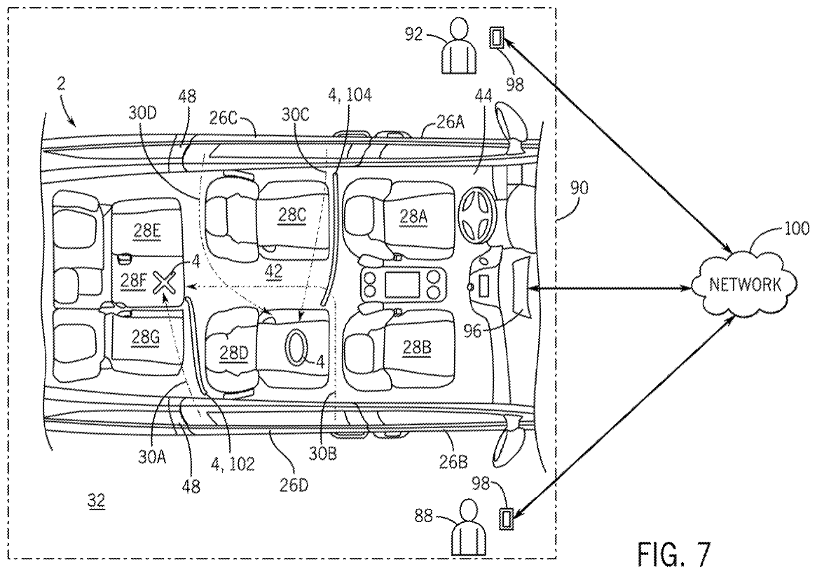

For providing a visual indication of i) a location of a predetermined door from among the plurality of doors 26, the light source 4 may be arranged on the predetermined door or on a door ring 34 of the predetermined door. The light source 4 may be activated such that when the predetermined door is in a closed position (FIG. 7), the emitted light is visible from the exterior 32 of the vehicle 2, e.g. around a periphery 36 of the predetermined door. The light source 4 may illuminate only the predetermined door, or may illuminate the predetermined door in different color light from that used to illuminate the remainder of the plurality of doors 26, so that the predetermined door is distinguished from the remainder of the plurality of doors 26 and thus identifies to the user that the vehicle 2 is the one that is intended for use by the user, and to identify the predetermined door as the door 26 that the user should use to access the interior 42 of the vehicle 2 to get to the predetermined seat.

Door seals 38 and/or door ring seals 40 may prevent the doors 26 from contacting the door rings 34 when the doors 26 are in a closed position, and thus there may be a space/gap between each of the doors 26 and the door rings 34 when the doors 26 are in a closed position. The light source 4 may be arranged radially outward from the door seals 38, radially outward from the door ring seals 40 on the door rings 34, or combinations thereof. This arrangement of the light source 4 on the doors 26 and/or door rings 34, and the space between the doors 26 and the door rings 34, may allow the emitted light to travel through the space and emanate to the exterior 32 of the vehicle 2 and thus be visible from the exterior 32 around the periphery 36 of the doors 26 as a backlight to the doors 26.

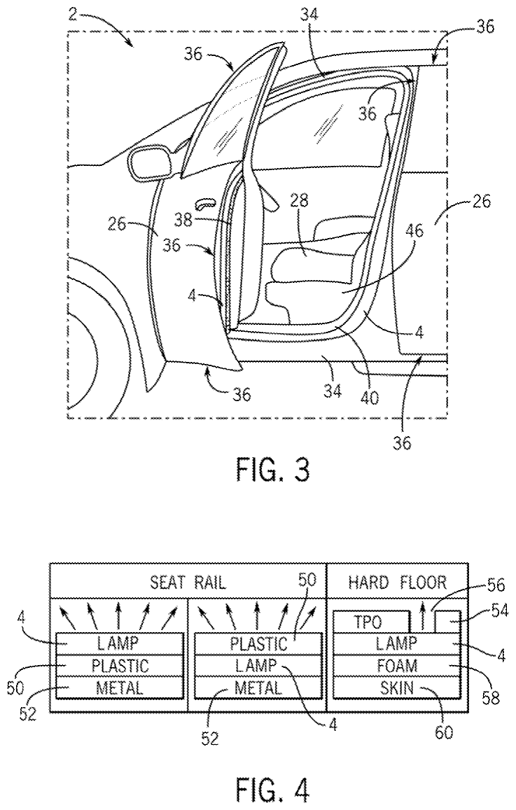

The activation of the light source 4 to indicate a location of a predetermined door from among the plurality of doors 26, may be based a proximity of the user to the vehicle 2, and may thus show the location of the predetermined door to the user. The light source 4 may also emit light when the door is in the open position (FIG. 3) to illuminate the door ring 34 to provide accent light to the door ring 34 or to help the user avoid running into the door ring 34 upon entry into the vehicle 2.

2. Predetermined Seat

For providing a visual indication of ii) a location of the predetermined seat, the light source 4 may be arranged on each of the seats 28, on a floor 44 in the interior 42 of the vehicle 2, on other components adjacent to the seats 28, or on combinations thereof. Each of these arrangements of the light source 4 may illuminate the predetermined seat, or may illuminate an area adjacent the predetermined seat in order to distinguish the predetermined seat from among the plurality of seats 28.

With reference to FIGS. 4-6, the light source 4 (indicated by “LAMP”) may be arranged as a separate component (FIG. 1) on a vehicle component, such as the vehicle doors 26 or door rings 34. Alternatively, the light source 4 of FIG. 1 may be arranged as part of a vehicle component, where the base layer 6 and top layer 16 may be formed from the various layers of the vehicle component itself. In accordance with the present subject matter, the light source 4 may be incorporated into a seat rail 46 or other plastic piece of the seats 28 (FIG. 3); into the seats 28 under a layer of polyester fabric, under a layer of thermoplastic polyurethane (TPU), or over a layer of leather (FIG. 4); into the floor 44 (FIG. 3); into a pillar 48 or dashboard adjacent to the seats 28 (FIG. 6), or at other locations. In each of these arrangements and others, the vehicle component may include a cover layer 16 that may covers the light source 4, and may define the exposed surface of the vehicle component. The cover layer 16 may allow the emitted light to pass therethrough and be visible to the user, and the cover layer 16 may be clear (optically transparent) or may be translucent and thereby camouflage the light source 4.

As depicted at the left in FIG. 4, the light source 4 may be arranged over a plastic layer 50, which is arranged over a metal layer 52. In this arrangement, the light source 4 may define an outermost layer of the structure of FIG. 4. As depicted at the middle in FIG. 4, the light source 4 may be arranged under the plastic layer 50 and over the metal layer 52. In this arrangement, the plastic layer 50 may define an outermost cover layer 16 of the structure and may be transparent (i.e. a clearcoat top layer) or translucent to the emitted light, and if translucent may camouflage the light source 4. As depicted at the right in FIG. 4, the light source 4 may be arranged under a thermoplastic olefin (“TPO”) layer 54, which may act as the cover layer 16 and may be somewhat opaque and thus not allow the emitted light to pass therethrough. The TPO layer 54 may thus include a void 56 that allows the emitted light to be visible. The light source 4 may be arranged over a foam layer 58, which may be arranged over a skin layer 60 on top of a metal structural layer (not shown) of the vehicle 2.

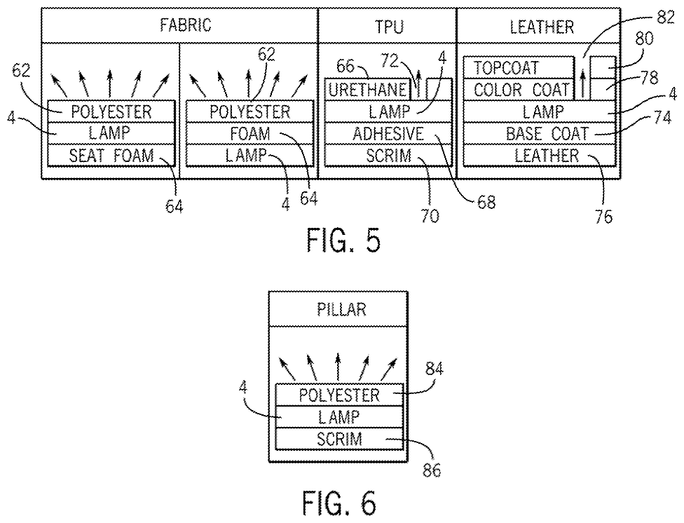

As depicted at the far left in FIG. 5, the light source 4 may be arranged under a polyester fabric layer 62 and over a seat foam layer 64. In this arrangement, the polyester fabric layer 62 may allow the emitted light to pass therethrough and be visible to the user. As depicted at the left middle in FIG. 5, the light source 4 may be arranged under the seat foam layer 64, which is arranged under the polyester fabric layer 62. In this arrangement, the polyester fabric layer 62 and the seat foam layer 64 both allow the emitted light to pass therethrough and be visible to the user. As depicted at the right middle in FIG. 5, the light source 4 may be arranged under a TPU layer 66, and over an adhesive layer 68, which may be used to attach the light source 4 to an underlying scrim layer 70. In this arrangement, the TPU layer 66 may be opaque and thus may include a void 72 to allow the emitted light to pass through the TPU layer 66 and be visible to the user. As depicted at the far right in FIG. 5, the light source 4 may be arranged over a base coat 74, which may be arranged over a leather layer 76. The light source 4 may be arranged under a color coat 78, which is arranged under a topcoat 80. In this arrangement, both of the color coat 78 and topcoat 80 may be opaque, and thus these may include voids 82 that allow the emitted light to pass therethrough to be visible to the user.

As depicted at the far left in FIG. 6, the light source 4 may be arranged under a polyester layer 84 (which may be fabric) and over a scrim layer 86, which scrim layer 86 may be arranged on a structural metal surface of the vehicle (e.g. an A-pillar, B-pillar, or C-pillar). In this arrangement, the polyester layer 84 allows the emitted light to pass therethrough and be visible to the user.

The light source 4 may be activated to illuminate only the predetermined seat, or may illuminate the predetermined seat in different color light from that used to illuminate the remainder of the plurality of seats 28, so that the predetermined seat is distinguished from the remainder of the plurality of seats 28 and is thus identified to the user as the seat 28 that the user should occupy (e.g. sit in) during subsequent travel of the vehicle 2. The light source 4 may be activated based on the predetermined door being moved from a close position (FIG. 7) to an open position (FIG. 2), or based on other criteria. The emitted light may be visible to the user from the interior 42 of the vehicle to allow the user to identify the predetermined seat from among the plurality of seats 28.

3. Predetermined Path

For providing an indication of the predetermined path, the light source 4 may be arranged on the floor 44 in the interior 42 of the vehicle 2, on other components adjacent to the seats 28, or on combinations thereof. In each of these arrangements, the light source 4 may be activated to emit light in the interior 42 of the vehicle to illuminate the predetermined path, which extends from the predetermined door or from the exterior 32, and to the predetermined seat.

The illumination may be in the form of an illuminated line or other shape leading from the predetermined door to the predetermined seat, an illuminated arrow pointing to the predetermined seat, or in other forms that identifies the predetermined path in order to distinguish the predetermined seat from among the plurality of paths 30.

The predetermined path may include, but is not limited to, the shortest route, the most direct route, the easiest route for the user to maneuver through, or the least obstructed route among the plurality of paths 30 that the user can take between the predetermined door and the predetermined seat.

4. Example

With reference to FIG. 7, an exemplary operation of a ride-share indication system will be described. Although not depicted, the system of FIG. 7 may include the arrangement of the light source 4 of and of FIGS. 1-6. As depicted, the user 88 is within a predetermined distance 90 from the vehicle 2. Because the vehicle 2 includes seven different seats 28A-28G, and four different doors 26A-26D by which the user 88 could enter the vehicle 2, the user 88 may not be aware of which of the doors 26A-26D would be easiest for the user to enter the vehicle 2, may not be aware of which of the seats 28A-28G the user 88 is to occupy (e.g. which of the seats 28A-28G is predetermined for occupancy by the user 88), and may not be aware of which of the paths 30 would be easiest for the user 88 to take to get to the assigned seat, e.g. predetermined seat 28F.

As depicted in FIG. 7, the user 88 is on a passenger side (i.e. right side) of the vehicle 2, and may be standing on a sidewalk adjacent to a street occupied by the vehicle 2. The predetermined seat 28F is assigned to the user 88 for occupancy during subsequent travel of the vehicle 2. The predetermined door 26D is the closest one of the doors 26A-26D to the predetermined seat 28F and is between the user 88 and the predetermined seat 28F. The predetermined door 26D may be determined based on the location of the user 88 in relation to the vehicle 2 (i.e. whether the user 88 is on a driver side or passenger side of the vehicle 2).

There are at least two different paths 30A-30B that the user 88 could take from the predetermined door 26D to reach the predetermined seat 28F. The predetermined path 30B may be determined based on the location of the user 88 in relation to the vehicle 2 (i.e. whether the user 88 is on a driver side or passenger side of the vehicle 2) and based on which of the doors 26 is the predetermined door. The predetermined path 30A is the most direct one of the paths 30A-30B between the predetermined door 26D and the predetermined seat 28F, and thus may be the easiest route for the user 88 to get to the predetermined seat 28F. However, taking the predetermined path 30A may require seat 28D to be moved forward to allow the user 88 to get to predetermined seat 28F. If another user were occupying seat 28D, such forward movement of the seat 28D may be inconvenient of may not be possible, and thus path 30B may be selected to be the predetermined path.

Identification of the vehicle 2 as that intended for use by the user 88, and the identification of the predetermined door 26D, may be indicated by the light source 4 on the predetermined door 26D or on the door ring 34 of the predetermined door 26D being activated to emit light around the periphery 36 of the predetermined door 26D that is visible to the user 88.

The predetermined path 30A may be indicated by activating the light source 4 on the floor 44 of the vehicle 2. This illumination provides a visual indication to the user 88 of the predetermined path 30A, and is shown to provide an illuminated line 102 extending between the predetermined door 26D and the predetermined seat 28F.

The predetermined seat 28F may be indicated by activating the light source 4 on the predetermined seat 28F. This illumination provides a visual indication to the user 88 of the location of the predetermined seat 28F, and is shown to provide an illuminated “X” on the predetermined seat 28F.

Identification of the vehicle 2, the predetermined door 26D, the predetermined path 30A, and the predetermined seat 28F may be accomplished in other ways by the light source 4, including different arrangements and operations of the light source 4.

Also shown in FIG. 7, a second user 92 has also reserved the use of the vehicle 2 and a second predetermined seat 28D is assigned to the second user 92. As depicted, the second user 92 is within the predetermined distance 90 from the vehicle 2, which may occur at the same time/location or at a different time/location than when/where the first user 88 entered the vehicle 2.

As depicted in FIG. 7, the second user 92 is on a driver side (i.e. left side) of the vehicle 2. The second predetermined seat 28D is assigned to the second user 92 for occupancy during subsequent travel of the vehicle 2. A second predetermined door 26C is the closest one of the doors 26A-26D to the second user 92 and is between the second user 92 and the second predetermined seat 28D, but is not the closest one of the doors 26A-26D to the second predetermined seat 28D, which in this case is door 26D. The second predetermined door 26C may be determined based on the location of the second user 92 in relation to the vehicle 2 (i.e. based on the second user 92 being on the driver side of the vehicle 2).

There are at least two different paths 30C-30D that the second user 92 could take from the second predetermined door 26C to reach the second predetermined seat 28D. The second predetermined path 30C may be determined based on the location of the second user 92 in relation to the vehicle 2 (i.e. whether the second user 92 is on a driver side or passenger side of the vehicle 2) and based on which of the doors 26 is the predetermined door 26C. In this regard, the second predetermined path 30C may be chose over any path starting from door 26D, because door 26D is not on the same side (i.e. driver side) of the vehicle 2 as the second user 92. The second predetermined path 30C is the most direct one of the paths 30C-30D between the second predetermined door 26C and the second predetermined seat 28D, and thus may be the easiest route for the user 88 to get to the second predetermined seat 28D. This is because taking the path 30D may require seat 28C to be moved forward to allow the second user 92 to get to predetermined seat 28D, which may be inconvenient and not the most direct route, and thus path 30C may be selected to be the second predetermined path.

Identification of the vehicle 2 as that intended for use by the second user 92, and the identification of the second predetermined door 26C, may be indicated by the light source 4 on the second predetermined door 26C or on the door ring 34 of the second predetermined door 26C being activated to emit light around the periphery 36 of the second predetermined door 26C that is visible to the second user 92. This emitted light may be of a different color than light emitted to identify the first predetermined door 26D for the first user 88. Where the first user 88 and the second user 92 are entering the vehicle 2 at the same time/location, the color differentiation between the light identifying the first predetermined door 26D and the second predetermined door 26C, allows the two users 88, 92 to correctly identify which of the doors they should enter to reach their respective assigned seats.

The second predetermined path 30C may be indicated by activating the light source 4 on the floor 44 of the vehicle 2. This illumination provides a visual indication to the second user 92 of the second predetermined path 30C, and is shown to provide an illuminated line 104 extending between the second predetermined door 26C and the second predetermined seat 28D.

The second predetermined seat 28D may be indicated by activating the light source 4 on the second predetermined seat 28D. This illumination provides a visual indication to the second user 92 of the location of the second predetermined seat 28D, and is shown to provide an illuminated “O” on the second predetermined seat 28D.

Identification of the vehicle 2, the second predetermined door 26C, the second predetermined path 30C, and the second predetermined seat 28D may be accomplished in other ways by the light source 4, including different arrangements and operations of the light source 4.

The light source 4 may be applied to an exterior surface of the vehicle 2, such as on a roof above the doors 26, on a panel below the doors 26, or to an exterior surface of the doors 26.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A light source arranged on an associated vehicle, wherein:
the light source has a sheet-like structure and is arranged on a door of the vehicle, or on a door ring of the door,
the light source emits light that is visible from an exterior of the vehicle, and
the emitted light indicates a location of the door of the vehicle.

2. The light source according to claim 1, wherein when the door is in a closed position, the emitted light is visible from the exterior of the vehicle around a periphery of the door.

3. The light source according to claim 2, wherein the light source is arranged radially outward from a door seal on the door or radially outward from a door ring seal on the door ring.

4. The light source according to claim 1, wherein:
the vehicle includes a plurality of doors including the door; and
the emitted light identifies the door as a predetermined door from among the plurality of doors.

5. The light source according to claim 4, wherein:
the light source is activated to emit light when a user of the vehicle comes within a predetermined distance from the vehicle; and
the predetermined door is closest among the plurality of doors to a predetermined seat within the vehicle for occupancy by the user.

6. The light source according to claim 5, wherein the light source is also activated to emit light when the predetermined door is in an open position to illuminate the door ring.

7. The light source according to claim 5, wherein:
the emitted light is a first emitted light, the user is a first user, the predetermined door is a first predetermined door, and the predetermined seat is a first predetermined seat;
the light source emits a second emitted light that identifies a second predetermined door from among the plurality of doors; and
the second predetermined door is closest to a second predetermined seat within the vehicle for occupancy by a second user.

8. The light source according to claim 7, wherein the first emitted light has a different color than the second emitted light.

9. The light source according to claim 1, wherein:
the light source is an electroluminescent light source defining two major surfaces that are oppositely directed from one another, and including:
a rear electrode,
a dielectric layer over the rear electrode,
a phosphor layer over the dielectric layer,
a front electrode over the phosphor layer,
a bus bar contacting the front electrode and in electrical connection with the front electrode, the rear electrode, and an associated power source, and
a clearcoat top layer over the front electrode;
the phosphor layer emits light from one of the two major surfaces when activated by power from the power source.

10. A system for providing indications to a user of a multi-occupant vehicle, the system including a light source and a power source operatively connected to the light source, wherein:
the light source is arranged on the vehicle and has a sheet-like structure, the light source emitting light when activated by power from the power source; and
the emitted light indicates a location of a predetermined seat, from among a plurality of seats within the vehicle, that is assigned to the user for occupancy by the user during travel of the vehicle.

11. The system according to claim 10, wherein:
the light source is arranged on the predetermined seat, on a floor of the vehicle, or on the predetermined seat and on the floor;
the predetermined seat or the floor includes an exposed surface defined by a covering layer;
the light source is covered by the covering layer; and
the emitted light is visible through the covering layer.

12. The system according to claim 11, wherein the light source is camouflaged by the covering layer.

13. The system according to claim 10, wherein the light source includes:
a rear electrode,
a dielectric layer over the rear electrode,
a phosphor layer over the dielectric layer,
a front electrode over the phosphor layer,
a bus bar contacting the front electrode and in electrical connection with the front electrode, the rear electrode, and the power source, and
a clearcoat layer over the front electrode,
wherein the phosphor layer emits light when activated by power from the power source.

14. The system according to claim 10, wherein:
the light source is also arranged on a plurality of doors of the vehicle or on a plurality of door rings of the plurality of doors;
the emitted light is visible from an exterior of the vehicle and indicates a location of a predetermined door from among the plurality of doors; and
the predetermined door is closest among the plurality of doors to the predetermined seat.

15. The system according to claim 10, the light source is activated to emit light when the user comes within a predetermined distance from the vehicle.

16. The system according to claim 10, wherein when the predetermined door is in a closed position, the emitted light is visible from the exterior of the vehicle around a periphery of the predetermined door

17. A vehicle including:
a plurality of seats arranged within the vehicle; and
a light source arranged on the vehicle and configured to emit light when activated;
wherein the emitted light indicates to a user a predetermined path, from among a plurality of paths, between an exterior of the vehicle to a predetermined seat from among the plurality of seats, and
wherein the predetermined seat is assigned to the user for occupancy by the user during travel of the vehicle.

18. The vehicle according to claim 17, further including a plurality of doors, wherein:
the emitted light is visible from an exterior of the vehicle to indicate a location of a predetermined door from among the plurality of doors that is in the predetermined path; and
the predetermined door is closest among the plurality of doors to the predetermined seat.

19. The vehicle according to claim 18, wherein the light source is arranged on the predetermined door or on a door ring of the predetermined door, such that when the predetermined door is in a closed position, the emitted light is visible from the exterior of the vehicle around a periphery of the predetermined door.

20. The vehicle according to claim 17, wherein:
the emitted light indicates a location of the predetermined seat;
the light source is arranged on the predetermined seat, on a floor of the vehicle, or on the predetermined seat and on the floor;
the predetermined seat or the floor includes an exposed surface defined by a covering layer;
the light source is covered by the covering layer; and
the emitted light is visible through the covering layer.
